(19) United States
(12) Patent Application Publication
(10) Pub. No.: US 2005/0043165 A1
(43) Pub. Date: Feb. 24, 2005

(54) Cathode-ray-tube panel for projection tube

(76) Inventor: Hiroshi Komori, Sakata-gun (JP)

Correspondence Address: KUBOVCIK & KUBOVCIK, SUITE 710, 900 17TH STREET NW, WASHINGTON, DC, 20006, US

(21) Appl. No.: 10/922,306

(22) Filed: Aug. 19, 2004

(30) Foreign Application Priority Data
Aug. 21, 2003 (JP) 2003-208127

(51) Int. Cl. C03C 3/078; C03C 3/087

(52) U.S. Cl. 501/72; 501/70

(57) ABSTRACT

A cathode-ray-tube panel for a projection tube according to the present invention is made of glass containing not less than 4 ppm of Nd₂O₃ or not less than 15 ppm of Pr₆O₁₁ on a mass percentage basis.

### BACKGROUND OF THE INVENTION

1. Field of the Invention

The present invention relates to a cathode-ray-tube panel for a projection tube.

2. Description of the Related Art

In recent years, large-size cathode ray tubes have been mainly used and, among these, the market of projection-type cathode ray tubes has been expanded.

The projection-type cathode ray tube has a configuration in which images released from three single-color projection-type cathode ray tubes of red, green and blue are enlarged by lenses and are projected onto a large-size screen (see JP-A 58-154145 (1983)).

An envelope of a single-color projection-type cathode ray tube is constituted by a panel unit on which images are projected, a tube-shaped neck unit to which an electron gun is attached and a funnel unit which has a funnel shape that is used for connecting the panel unit and the neck unit. An electron beam, released from the electron gun, allows a fluorescent material formed on the inner face of the panel unit to emit light so that an image is projected on the panel unit. At this time, bremsstrahlung X-rays occur in the tube. When the bremsstrahlung X-rays leak outside the tube through the envelope, adverse effects are exerted to the human body; therefore, glass having a high X-ray absorbing performance is used in the envelope of this type.

In order to increase the X-ray absorbing coefficient of the glass forming the envelope, PbO is contained in the glass. In this case, however, when the glass containing PbO is used as panel glass, coloring referred to as browning is caused by electron beams and X-ray irradiation to be applied upon projecting an image, resulting in a problem that the image becomes difficult to observe.

For this reason, the glass is allowed to contain a large amount of SrO or BaO in place of PbO, so that cathode-ray-tube panel glass for a projection tube, which is less susceptible to browning and has a high X-ray absorbing performance, has been developed (see JP-A 2001-302277).

In general, the projection-type cathode ray tube is superior in the light-emitting efficiency of its blue fluorescent material in comparison with its red and green fluorescent materials; therefore, when an image is projected by commonly applying the same current and same voltage to three projection tubes of red, green and blue, the resulting image has a stronger blue tone.

Therefore, in order to suppress this blue tone, various methods have been proposed: the applied current and applied voltage to the projection tubes of the respective colors are changed; and the focus is obscured with respect to only the image projected from the blue-color projection tube.

However, changing the applied current and the applied voltage requires a current adjusting device and a voltage adjusting device. Further, obscuring the focus with respect to only the image projected from the blue-color projection tube also requires a balance-adjusting process for the images to be projected from the three projection tubes, resulting in high product costs.

### SUMMARY OF THE INVENTION

An object of the present invention is to provide a cathode-ray-tube panel for a projection tube that can suppress a blue tone in an image without the necessity of adjustments of applied current and applied voltage and adjustments for obscuring the focus of a blue-color projection tube, which cause high costs.

The present inventors have carried out various experiments repeatedly and found that, by adding Nd₂O₃ and Pr₆O₁₁ to glass to be used as a projection-type cathode-ray-tube panel, the transmittance of the glass in short wavelengths can be reduced, so that it becomes possible to suppress a blue tone in an image without the necessity of adjustments causing high costs; thus, the present invention has been proposed.

In other words, the cathode-ray-tube panel for a projection tube according to the present invention is made of glass that contains not less than 4 ppm of Nd₂O₃ or not less than 15 ppm of Pr₆O₁₁ on a mass percentage basis.

The glass that has been used in conventional cathode-ray-tube panels for a projection tube is not glass having a selective photo-absorbing band, with the result that the intensity of a blue light ray becomes higher. In contrast, the cathode-ray-tube panel for a projection tube according to the present invention is made of glass having a selective photo-absorbing band; therefore, it becomes possible to reduce the intensity of a light ray projected from a blue-color projection-type cathode ray tube. Consequently, the projected light ray is well balanced with light rays projected from red-color and green-color projection-type cathode ray tubes, thereby making it possible to suppress a blue tone in an image projected onto a screen.

With respect to means for obtaining glass having a selective photo-absorbing band, the present invention allows glass to contain Nd₂O₃ or Pr₆O₁₁. Here, both of the materials may be used in combination.

Upon adding Nd₂O₃ to glass, the content needs to be set to not less than 4 ppm. The content of less than 4 ppm fails to provide glass having a selective photo-absorbing band, making it difficult to obtain an effect of reducing intensity of light to be projected from the blue-color projection-type cathode ray tube. In contrast, when the content becomes too high, it becomes difficult to maintain a well-balanced state with light rays projected from the red-color and green-color projection-type cathode ray tubes; therefore, it is desirable to set the content of Nd₂O₃ to not more than 100 ppm. Preferably, it is set in a range from 5 to 100 ppm, more preferably in a range from 7 to 100 ppm. Here, when the content of Pr₆O₁₁ is not less than 15 ppm, the content of Nd₂O₃ may be set to less than 4 ppm.

Upon adding Pr₆O₁₁ to glass, the content needs to be set to not less than 15 ppm. The content of less than 15 ppm fails to provide glass having a selective photo-absorbing band, making it difficult to obtain an effect of reducing intensity of light to be projected from the blue-color projection-type cathode ray tube. In contrast, when the content becomes too high, it becomes difficult to maintain a well-balanced state with light rays projected from the red-color and green-color projection-type cathode ray tubes; therefore, it is desirable to set the content of Pr₆O₁₁ to not more than 1000 ppm. Preferably, it is set in a range from 20 to 1000 ppm, more preferably in a range from 25 to 1000 ppm. Here, when the content of Nd₂O₃ is not less than 4 ppm, the content of Pr₆O₁₁ may be set to less than 15 ppm.

Moreover, the cathode-ray-tube panel for a projection tube according to the present invention is preferably made of glass having an X-ray absorbing coefficient of not less than 36.0 cm⁻¹. The X-ray absorbing coefficient of less than 36.0 cm⁻¹ tends to cause leakage of X rays that exert adverse effects to the human body from the tube. In order to increase the X-ray absorbing coefficient, preferably, materials such as SrO, BaO, ZnO and ZrO₂ may be added to the glass.

Here, preferable composition ranges that are suitable for the cathode-ray-tube panel for a projection tube according to the present invention are shown as follows, without substantially containing PbO, on a mass percentage basis: 50 to 60% of SiO₂, 0 to 3% of Al₂O₃, 0 to 3% of MgO, 0 to 3% of CaO, 5 to 11% of SrO, 8 to 16% of BaO, 5 to 9% of ZnO, 0.1 to 3% of Li₂O, 1 to 6% of Na₂O, 5 to 14% of K₂O, 0.1 to 3% of ZrO₂, 0 to 2% of TiO₂, 0 to 2% of CeO₂, 0 to 1% of Sb₂O₃, and 0 to 0.5% of Fe₂O₃.

The reason for the above-mentioned limitations to the glass composition in the present invention is as follows.

Although PbO is a component used for improving the X-ray absorbing performance of glass, addition of PbO tends to cause coloring referred to as browning due to electron beam and X-ray irradiation; therefore, it is preferable to avoid the application of PbO to the glass of the present invention.

Here, SiO₂ is a network former of glass. When the content thereof becomes higher, the glass viscosity becomes higher to cause difficulty in fusing and to make the thermal expansion coefficient become too small, with the result that it becomes difficult to provide proper consistency with the funnel glass. Further, when the content is too low, the viscosity of glass becomes too low, making it difficult to carry out molding processes, and the thermal expansion coefficient becomes too high, making it difficult to provide proper consistency with the funnel glass. When the content of SiO₂ is in a range from 50 to 60%, it becomes possible to obtain glass having a thermal expansion coefficient that provides proper consistency with the funnel glass, without causing degradation in the fusing property and moldability of glass. The range is preferably set from 52 to 58%.

Further, Al₂O₃ is also a component to form a network former of glass. When the content thereof becomes higher, reaction products, referred to as leucite and potassium feldspar, are generated through reactions with refractories to cause degradation in the productivity. When the content of Al₂O₃ is in a range from 0 to 3%, it becomes possible to obtain glass that is less susceptible to generation of the reaction products with refractories. The range is preferably set from 0 to 2%.

MgO and CaO are components that make glass easily fused and adjust the thermal expansion coefficient and viscosity thereof. When the content of each of the components becomes higher, the glass tends to have devitrification and also to have a difficulty in molding. When the content of each of MgO and CaO is set in a range from 0 to 3%, it becomes possible to easily obtain glass that is less susceptible to devitrification. Each of the ranges is preferably set from 0 to 2%.

SrO is a component that makes glass easily fused and adjusts the thermal expansion coefficient and viscosity to improve the X-ray absorbing performance. When the content is excessive, the glass becomes more susceptible to devitrification and tends to have difficulty in molding. In contrast, the insufficient content tends to fail to provide a sufficient X-ray absorbing performance. When the content of SrO is set in a range from 5 to 11%, it becomes possible to provide glass that has a sufficient X-ray absorbing coefficient without devitrification in the glass. The range is preferably set from 6 to 10%.

In the same manner as SrO, BaO is also a component that makes glass easily fused and adjusts the thermal expansion coefficient and viscosity to improve the X-ray absorbing performance. When the content is excessive, the glass becomes more susceptible to devitrification and tends to have difficulty in molding. In contrast, the insufficient content tends to fail to provide a sufficient X-ray absorbing performance. When the content of BaO is set in a range from 8 to 16%, it becomes possible to provide glass that has a sufficient X-ray absorbing coefficient without devitrification in the glass. The range is preferably set from 9 to 15%.

In the same manner as SrO and BaO, ZnO is also a component that makes glass easily fused and adjusts the thermal expansion coefficient and viscosity to improve the X-ray absorbing performance. When the content is excessive, the glass becomes more susceptible to devitrification and tends to have difficulty in molding. In contrast, the insufficient content tends to fail to provide a sufficient X-ray absorbing performance. When the content of ZnO is set in a range from 5 to 9%, it becomes possible to provide glass that has a sufficient X-ray absorbing coefficient without devitrification in the glass. The range is preferably set from 6 to 8%.

Moreover, Li₂O is a component that is used for adjusting the thermal expansion coefficient and the viscosity. When the content becomes too high, the thermal expansion coefficient become too high, with the result that it becomes difficult to provide proper consistency with the funnel glass, and the viscosity becomes too low to cause difficulty in molding. Further, the electric insulating property tends to be lowered. In contrast, when the content becomes too low, the thermal expansion coefficient become too low, with the result that it becomes difficult to provide proper consistency with the thermal expansion coefficient of the funnel glass. When the content of Li₂O is in a range from 0.1 to 3%, it becomes possible to easily obtain glass having a thermal expansion coefficient that provides proper consistency with the funnel glass, without causing degradation in the moldability and electric insulating property. The range is preferably set from 0.5 to 2.5%.

In the same manner as Li₂O, Na₂O is also a component that is used for adjusting the thermal expansion coefficient and the viscosity. When the content becomes too high, the thermal expansion coefficient become too high, with the result that it becomes difficult to provide proper consistency with the funnel glass, and the viscosity becomes too low to cause difficulty in molding. Further, the electric insulating property tends to be lowered. In contrast, when the content becomes too low, the thermal expansion coefficient become too low, with the result that it becomes difficult to provide proper consistency with the thermal expansion coefficient of the funnel glass. When the content of Na₂O is in a range from 1 to 6%, it becomes possible to easily obtain glass having a thermal expansion coefficient that provides proper consistency with the funnel glass, without causing degradation in the moldability and electric insulating property. The range is preferably set from 2 to 5%.

In the same manner as Li₂O and Na₂O, K₂O is also a component that is used for adjusting the thermal expansion coefficient and the viscosity. When the content becomes too high, the thermal expansion coefficient become too high, with the result that it becomes difficult to provide proper consistency with the funnel glass, and the viscosity becomes too low to cause difficulty in molding. Further, the electric insulating property tends to be lowered. In contrast, when the content becomes too low, the thermal expansion coefficient become too low, with the result that it becomes difficult to provide proper consistency with the thermal expansion coefficient of the funnel glass. When the content of K₂O is in a range from 5 to 14%, it becomes possible to easily obtain glass having a thermal expansion coefficient that provides proper consistency with the funnel glass, without causing degradation in the moldability and electric insulating property. The range is preferably set from 6 to 13%.

Moreover, ZrO₂ is a component that adjusts the thermal expansion coefficient and viscosity, and further improves the X-ray absorbing performance. When the content is excessive, the glass becomes more susceptible to devitrification and tends to have difficulty in molding. In contrast, the insufficient content tends to fail to provide a sufficient X-ray absorbing performance. When the content of ZrO₂ is set in a range from 0.1 to 3%, it becomes possible to provide glass that has a sufficient X-ray absorbing coefficient without devitrification in the glass. The range is preferably set from 0.1 to 2%.

TiO₂ is a component that reduces the transmittance of a wavelength of 400 nm, and suppresses ultraviolet-ray coloring in glass. The content of TiO₂ exceeding 2% fails to provide the corresponding effects, making the material costs higher. The range is preferably set from 0.1 to 1%.

CeO₂ is a component that reduces the transmittance of a wavelength of 400 nm, and suppresses X-ray coloring in glass. The content of CeO₂ exceeding 2% fails to provide the corresponding effects, making the material costs higher. The range is preferably set from 0.1 to 1%.

Sb₂O₃ is a component that reduces the transmittance of a wavelength of 400 nm, and also serves as a clarifier. The content of Sb₂O₃ exceeding 1% fails to provide the corresponding effects, making the material costs higher. The range is preferably set from 0.05 to 0.8%.

Fe₂O₃ is a component that reduces the transmittance of a wavelength of 400 nm. The excessive content of Fe₂O₃ tends to also reduce the transmittance of a red wavelength band. The range is preferably set from 0.005 to 0.2%.

Here, in addition to the above-mentioned components, P₂O₅ may be added up to 0.5% as a component for suppressing devitrification.

Next, description will be given of a manufacturing method of the cathode-ray-tube panel for a projection tube.

First, glass materials are adjusted and mixed to have the above-mentioned glass composition range. Next, the glass materials thus prepared are put into a continuous fusing furnace, and fusing and defoaming processes are carried out; then, the fused glass is supplied into a molding device to be press-molded, and gradually cooled. Through these processes, the cathode-ray-tube panel for a projection tube is obtained.

Herein, the cathode-ray-tube panel for a projection tube thus obtained may be used not only for a blue-color panel, but also for red-color and green-color cathode-ray-tube panels for a projection tube.

### DESCRIPTION OF THE PREFERRED EXAMPLES

Hereinafter, description will be given of a cathode-ray-tube panel for a projection tube according to the present invention in detail by way of examples.

Tables 1 to 4 show examples (samples 1 to 13) and comparative examples (samples 14 to 16) of the present invention.

TABLE 1

| | Example | | | |
|---|---|---|---|---|
| Composition (% by mass) | 1 | 2 | 3 | 4 |
| SiO₂ | 52.78 | 52.78 | 52.78 | 53.345 |
| Al₂O₃ | 1.0 | 1.0 | 1.0 | 2.0 |
| MgO | 1.0 | 1.0 | 1.0 | 2.0 |
| CaO | 1.0 | 1.0 | 1.0 | — |
| SrO | 9.0 | 9.0 | 9.0 | 10.0 |
| BaO | 13.0 | 13.0 | 13.0 | 10.0 |
| ZnO | 7.0 | 7.0 | 7.0 | 6.0 |
| Li₂O | 1.0 | 1.0 | 1.0 | 2.0 |
| Na₂O | 3.0 | 3.0 | 3.0 | 5.0 |
| K₂O | 9.0 | 9.0 | 9.0 | 8.0 |
| ZrO₂ | 1.0 | 1.0 | 1.0 | 0.5 |
| TiO₂ | 0.5 | 0.5 | 0.5 | 0.1 |
| CeO₂ | 0.5 | 0.5 | 0.5 | 1.0 |
| Sb₂O₃ | 0.2 | 0.2 | 0.2 | 0.05 |
| Fe₂O₃ | 0.02 | 0.02 | 0.02 | 0.005 |
| Nd₂O₃ | 4 ppm | — | 25 ppm | 2 ppm |
| Pr₆O₁₁ | — | 15 ppm | 20 ppm | 40 ppm |
| X-ray Absorbing | 38 | 38 | 38 | 36 |
| Coefficient (0.6 Å, cm⁻¹) | | | | |
| Sum of S(λ)Z(λ)T(λ) | 526.0 | 525.9 | 518.1 | 513.6 |

TABLE 2

| | Example | | | |
|---|---|---|---|---|
| Composition (% by mass) | 5 | 6 | 7 | 8 |
| SiO₂ | 56.65 | 56.65 | 56.65 | 52.4 |
| Al₂O₃ | 0.1 | 0.1 | 0.1 | 0.5 |
| MgO | — | — | — | — |
| CaO | — | — | — | 1.0 |
| SrO | 8.0 | 8.0 | 8.0 | 6.0 |
| BaO | 12.0 | 12.0 | 12.0 | 15.0 |
| ZnO | 8.0 | 8.0 | 8.0 | 6.0 |
| Li₂O | 0.5 | 0.5 | 0.5 | 0.1 |
| Na₂O | 3.0 | 3.0 | 3.0 | 2.0 |
| K₂O | 10.0 | 10.0 | 10.0 | 13.0 |
| ZrO₂ | 0.1 | 0.1 | 0.1 | 2.0 |
| TiO₂ | 0.1 | 0.1 | 0.1 | 1.0 |
| CeO₂ | 1.0 | 1.0 | 1.0 | 0.1 |
| Sb₂O₃ | 0.5 | 0.5 | 0.5 | 0.8 |
| Fe₂O₃ | 0.05 | 0.05 | 0.05 | 0.1 |
| Nd₂O₃ | 2 ppm | 2 ppm | 10 ppm | 15 ppm |
| Pr₆O₁₁ | 20 ppm | 20 ppm | 13 ppm | 100 ppm |
| X-ray Absorbing | 36 | 36 | 36 | 37 |
| Coefficient (0.6 Å, cm⁻¹) | | | | |
| Sum of S(λ)Z(λ)T(λ) | 516.5 | 516.5 | 516.4 | 505.0 |

TABLE 3

| | Example | | | |
|---|---|---|---|---|
| Composition (% by mass) | 9 | 10 | 11 | 12 |
| SiO₂ | 52.4 | 53.6 | 53.6 | 54.85 |
| Al₂O₃ | 0.5 | 1.5 | 1.5 | 1.0 |
| MgO | — | 0.5 | 0.5 | 0.2 |
| CaO | 1.0 | 2.0 | 2.0 | 0.5 |
| SrO | 6.0 | 9.0 | 9.0 | 7.5 |
| BaO | 15.0 | 9.0 | 9.0 | 12.5 |
| ZnO | 6.0 | 8.0 | 8.0 | 7.5 |
| Li₂O | 0.1 | 2.5 | 2.5 | 1.5 |
| Na₂O | 2.0 | 4.0 | 4.0 | 3.5 |
| K₂O | 13.0 | 7.0 | 7.0 | 8.5 |
| ZrO₂ | 2.0 | 1.5 | 1.5 | 1.2 |
| TiO₂ | 1.0 | 0.3 | 0.3 | 0.8 |
| CeO₂ | 0.1 | 0.5 | 0.5 | 0.2 |
| Sb₂O₃ | 0.8 | 0.4 | 0.4 | 0.1 |
| Fe₂O₃ | 0.1 | 0.2 | 0.2 | 0.15 |
| Nd₂O₃ | 70 ppm | 95 ppm | 3 ppm | 20 ppm |
| Pr₆O₁₁ | — | — | 250 ppm | 500 ppm |
| X-ray Absorbing | 37 | 37 | 37 | 36 |
| Coefficient (0.6 Å, cm⁻¹) | | | | |
| Sum of S(λ)Z(λ)T(λ) | 503.5 | 498.2 | 495.1 | 490.2 |

TABLE 4

| | Example | Comparative Example | | |
|---|---|---|---|---|
| Composition (% by mass) | 13 | 14 | 15 | 16 |
| SiO₂ | 54.85 | 52.78 | 52.78 | 52.78 |
| Al₂O₃ | 1.0 | 1.0 | 1.0 | 1.0 |
| MgO | 0.2 | 1.0 | 1.0 | 1.0 |
| CaO | 0.5 | 1.0 | 1.0 | 1.0 |
| SrO | 7.5 | 9.0 | 9.0 | 9.0 |
| BaO | 12.5 | 13.0 | 13.0 | 13.0 |
| ZnO | 7.5 | 7.0 | 7.0 | 7.0 |
| Li₂O | 1.5 | 1.0 | 1.0 | 1.0 |
| Na₂O | 3.5 | 3.0 | 3.0 | 3.0 |
| K₂O | 8.5 | 9.0 | 9.0 | 9.0 |
| ZrO₂ | 1.2 | 1.0 | 1.0 | 1.0 |
| TiO₂ | 0.8 | 0.5 | 0.5 | 0.5 |
| CeO₂ | 0.2 | 0.5 | 0.5 | 0.5 |
| Sb₂O₃ | 0.1 | 0.2 | 0.2 | 0.2 |
| Fe₂O₃ | 0.15 | 0.02 | 0.02 | 0.02 |
| Nd₂O₃ | 55 ppm | — | 3 ppm | — |
| Pr₆O₁₁ | 150 ppm | — | — | 13 ppm |
| X-ray Absorbing | 36 | 38 | 38 | 38 |
| Coefficient (0.6 Å, cm⁻¹) | | | | |
| Sum of S(λ)Z(λ)T(λ) | 496.4 | 527.6 | 526.9 | 526.5 |

The respective samples in the tables were prepared in the following manner.

First, a material batch, prepared to have the glass composition as shown in each of the tables, was put into a quartz crucible and was fused in a fusing furnace at about 1450° C. for 2 hours. In order to obtain homogeneous glass, this was stirred for 3 minutes by using a platinum stirring stick so as to carry out a defoaming process in the middle of the process. Successively, after the fused glass was molded into a predetermined shape, it was gradually cooled.

With respect to each of the resulting samples thus obtained, the sum of S(λ)Z(λ)T(λ), indicating a X-ray absorbing coefficient and intensity of blue-color light of each of the samples, was measured and indicated in the tables.

As clearly shown by the tables, each of the samples 1 to 13 derived from the examples had a high X-ray absorbing coefficient of not less than 36 cm⁻¹, and also had a low sum of S(λ)Z(λ)T(λ) of not more than 526.0.

In contrast, each of the samples 14 to 16 derived from the comparative examples had a high X-ray absorbing coefficient of not less than 36 cm⁻¹; however, a sum of S(λ)Z(λ)T(λ) thereof was not less than 526.5.

Herein, the X-ray absorbing coefficient was calculated and found as an absorbing coefficient with respect to a wavelength of 0.6 angstrom based upon glass composition and density.

Moreover, the sum of S(λ)Z(λ)T(λ) was found by the following processes: each of the samples was cut into 30 mm square, and after having been optically polished so as to have a thickness of 11.43 mm, the measurements of light transmittance T(λ) were carried out thereon for every 100 nm in a wavelength in a range from 380 to 780 nm by means of a spectrophotometer using a B22 light source, and each of the resulting values was multiplied by a multiple valence coefficient S(λ)Z(λ) for each wavelength and the sum was found.

Herein, the multiple valence coefficient S(λ)Z(λ) for each wavelength was calculated in accordance with JIS Z 8701, and was used, and the light transmittance was calculated with 100% being set to 1. In this case, the smaller the sum of S(λ)Z(λ)T(λ), the smaller the intensity of blue color light.

Moreover, each of the material batches of the samples 1, 2 and 3 and the sample 14 was fused in a fusing pot, and the resulting fused glass was press-molded to form a cathode-ray-tube panel for a projection tube. Successively, a blue-color cathode ray tube which was coated with a blue fluorescent material on its panel inner face was prepared, and an image was projected thereon, so that the suppressing effect of blue-color light intensity was evaluated based upon visual sense.

As a result, with respect to the samples 1, 2 and 3 Of the examples of the present invention, the intensity of blue-color light was suppressed in comparison with that of the sample 14 which contained neither Nd₂O₃ nor Pr₆O₁₁.

As described above, since the cathode-ray-tube panel for a projection tube according to the present invention has a high X-ray absorbing coefficient and is made of glass that has a selective light-absorbing band, it becomes possible to weaken only the intensity of light emitted from a blue-color projection-type cathode ray tube. Therefore, it becomes possible to suppress blue tone in an image projected on a screen without the necessity of adjusting applied current, applied voltage and focus. Therefore, this panel is suitably used as a cathode-ray-tube panel for a projection tube.

1. A cathode-ray-tube panel for a projection tube, composed of glass containing not less than 4 ppm of Nd₂O₃ or not less than 15 ppm of Pr₆O₁₁ on a mass percentage basis.

2. The cathode-ray-tube panel for a projection tube according to claim 1, wherein the glass contains Nd₂O₃ in a range of 4 to 100 ppm or Pr₆O₁₁ in a range of 15 to 1000 ppm on a mass percentage basis.

3. The cathode-ray-tube panel for a projection tube according to claim 1, wherein the glass does not substantially contain PbO, but contains 50 to 60% of SiO₂, 0 to 3% of Al₂O₃, 0 to 3% of MgO, 0 to 3% of CaO, 5 to 11% of SrO, 8 to 16% of BaO, 5 to 9% of ZnO, 0.1 to 3% of Li₂O, 1 to 6% of Na₂O, 5 to 14% of K₂O, 0.1 to 3% of ZrO₂, 0 to 2% of TiO₂, 0 to 2% of CeO₂, 0 to 1% of Sb₂O₃, and 0 to 0.5% Fe₂O₃ On a mass percentage basis.

4. The cathode-ray-tube panel for a projection tube according to claim 1, wherein the glass has an X-ray absorbing coefficient of not less than 36.0 cm⁻¹ at a wavelength of 0.6 angstrom.

5. The cathode-ray-tube panel for a projection tube according to claim 2, wherein the glass does not substantially contain PbO, but contains 50 to 60% of SiO₂, 0 to 3% of Al₂O₃, 0 to 3% of MgO, 0 to 3% of CaO, 5 to 11% of SrO, 8 to 16% of BaO, 5 to 9% of ZnO, 0.1 to 3% of Li₂O, 1 to 6% of Na₂O, 5 to 14% of K₂O, 0.1 to 3% of ZrO₂, 0 to 2% of TiO₂, 0 to 2% of CeO₂, 0 to 1% of Sb₂O₃, and 0 to 0.5% Fe₂O₃ On a mass percentage basis.

6. The cathode-ray-tube panel for a projection tube according to claim 2, wherein the glass has an X-ray absorbing coefficient of not less than 36.0 cm⁻¹ at a wavelength of 0.6 angstrom.
